(19) United States
(12) Patent Application Publication
(10) Pub. No.: US 2002/0043295 A1
(43) Pub. Date: Apr. 18, 2002

(54) Stump cutting tooth and pocket

(76) Inventor: Kevin J. Green, Blissfield, MI (US)

Correspondence Address: Joseph G. Burgess, Warn, Burgess & Hoffmann, PC, Suite B125, 691 North Squirrel Road, Auburn Hills, MI, 48326, US

(21) Appl. No.: 09/909,776

(22) Filed: Jul. 19, 2001

Related U.S. Application Data
(60) Provisional application No. 60/219,299, filed on Jul. 19, 2000.

(51) Int. Cl. B27C 1/00; B27C 5/00; B27G 13/00

(52) U.S. Cl. 144/241

(57) ABSTRACT

A stump cutting tool for use with a stump cutting apparatus having a rotatable cutting wheel or drum having at least one cutting tool mounted to the wheel or drum. The cutting tool includes a tool holder or pocket used to secure a separate cutting tooth. The pocket or tool holder includes the least one bore extending therethrough for use in securing the cutting tool to the cutting wheel or drum.

This application is based on and claims priority in U.S. Provisional Patent Application Ser. No. 60/219,299 filed Jul. 19, 2000.

### BACKGROUND OF THE INVENTION

1. Field of the Invention

The present invention relates generally to a stump cutting apparatus and, more specifically, to a stump cutting tool for use with a stump cutting apparatus.

2. Description of the Related Art

Various types of stump cutting devices are known. One type includes a rotatable disk having a plurality of cutting tools fastened to the peripheral edge thereof. A second type includes a rotatable drum having a plurality of cutting tools fastened to an outer circumferential surface thereof. During operation, the disk or drum rotates such that the cutting tools engage and cut the stump. Various types of cutting tools are used with either stump cutting apparatus. The cutting tool typically includes a tool holder or pocket secured to the cutting wheel or drum and a cutting tooth secured by the pocket to the cutting wheel. Such a cutting tool is referred to as a two-piece cutting tool because the pocket and cutting tooth are two separate pieces. In addition, a one-piece cutting tool, wherein the entire cutting tool assembly is complete in one piece and fastened to the wheel as a single unit is known. Two-piece cutting tools have an advantage in that the cutting tooth can be removed and replaced without removing the pocket or tool holder from the cutting wheel or drum.

### SUMMARY OF THE INVENTION

Accordingly, the present invention provides a stump cutting tool including a tool holder or pocket used to secure a separate cutting tooth to a cutting wheel or drum of a stump cutter apparatus. The stump cutting tool includes a pocket or tool holder including at least one bore extending therethrough for use in securing the pocket to the cutting wheel or drum. The pocket further includes a bore in the pocket. The cutting tool is disposed and secured within the bore. The cutting tool includes a carbide or hard cutting tip attached to one end of the cutting tooth. The present invention may also include a cutting tool locating stop used to properly locate or position the cutting tip with respect to the pocket or tool holder. Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a side view of a stump cutting tool assembly, according to the present invention, illustrated in use with a stump cutting apparatus;

FIG. 2 is a perspective view of a cutting tool according to the present invention;

FIG. 3 is a perspective view of a pocket of the cutting tool according to the present invention;

FIG. 4 is an additional perspective view of a pocket of the cutting tool according to the present invention;

FIG. 5 is a perspective view of a cutting tooth of the cutting tool according to the present invention;

FIG. 6 is a perspective view of an additional embodiment of the cutting tool according to the present invention;

FIG. 7 is a side view of an alternative embodiment of the cutting tool according to the present invention;

FIG. 8 is a side view of yet another embodiment of a cutting tool according to the present invention;

FIG. 9 is an exploded perspective view of the cutting tool assembly of FIG. 8;

FIG. 10 is a side view of a further embodiment of a cutting tool according to the present invention;

FIG. 11 it is a top view of a pocket and fastener assembly for use with a cutting tool according to the present invention;

FIG. 12 is a perspective rear view of yet a further embodiment of the cutting tool according to the present invention;

FIG. 13 is a perspective front view of the cutting tool assembly of FIG. 12;

FIG. 14 is a top view of the pockets of the cutting tool assembly of FIG. 12;

FIG. 15 is a perspective side view of one of the pockets of the cutting tool assembly of FIG. 12;

FIG. 16 is a perspective side view of the inner or mounting surface of one of the pockets of the cutting tool assembly of FIG. 12;

FIG. 17 is a perspective side view of the outer surface of one of the pockets of the cutting tool assembly of FIG. 12;

FIGS. 18 and 18a are side views of a cutting tooth for use with the cutting tool assembly of FIG. 12;

FIG. 19 is a top view of a pocket and exemplary cutting tooth having a stop member according to the present invention;

FIG. 20 is a cross-sectional view of a pocket and cutting tooth forming a cutting tool according to the present invention having a stop attached to the cutting tooth; and

FIG. 21 is a front view of the cutting tooth of FIG. 20.

### DETAILED DESCRIPTION OF THE PREFERRED EMBODIMENT(S)

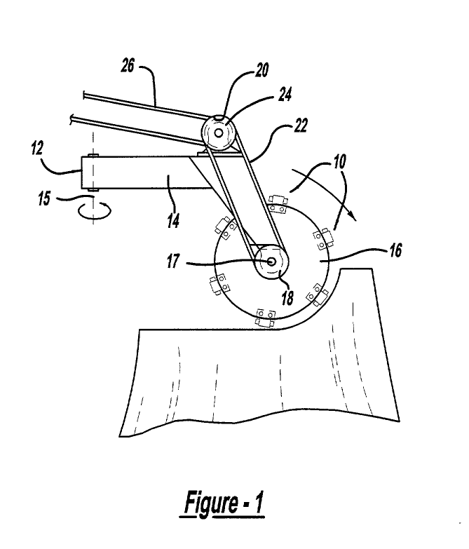

Referring to FIG. 1, a stump cutting tool assembly 10 according to the present invention is illustrated in operational relationship with a stump cutting apparatus, generally indicated at 12. The stump cutting apparatus 12 includes a wheel frame 14 pivotally supported for pivotal movement about an axis 15 to a remaining portion (not shown) of the stump cutting apparatus 12. The stump cutting apparatus 12 also includes a cutting wheel or drum 6 rotatably mounted at the other end of the wheel frame 14 for rotational movement about an axis 17. The stump cutting apparatus 12 includes a first pulley 18 attached to the cutting wheel 16 and a second pulley 20 attached to the wheel frame 14. The stump cutting apparatus 12 also includes a belt 22 interconnecting the first pulley 18 and second pulley 20. The stump cutting apparatus 12 includes a third pulley 24 connected to the second pulley 20. The stump cutting apparatus 12 further includes a second belt 26 interconnecting the third pulley 24 and a rotational source such as a motor (not shown). The rotational source rotatably moves the second belt 26 to rotate the third pulley 24, in turn, rotating the second pulley 20. Rotation of the second pulley 20 causes the first belt 22 to move, in turn rotating the first pulley 18 and cutting wheel 16. It should be appreciated that the stump cutting apparatus 12 is conventional and known in the art. Also, while shown herein with a cutting disk or wheel 16, the stump cutting tool assembly 10 according to the present invention may be used with a cutting drum.

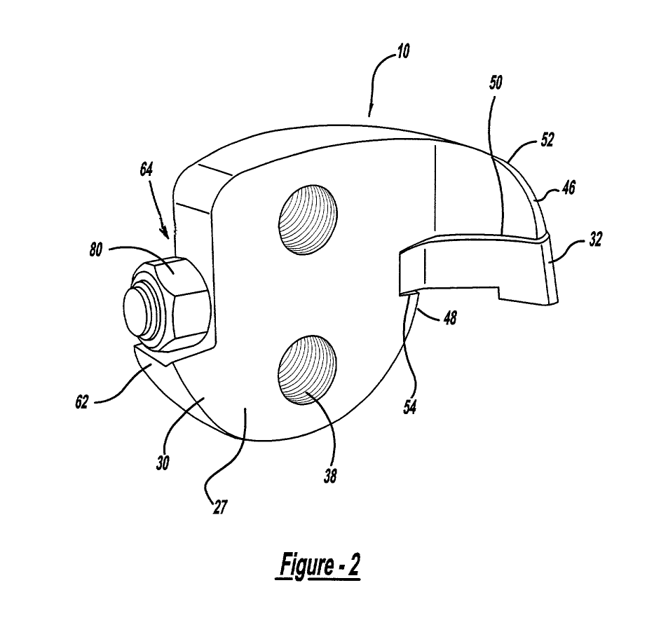

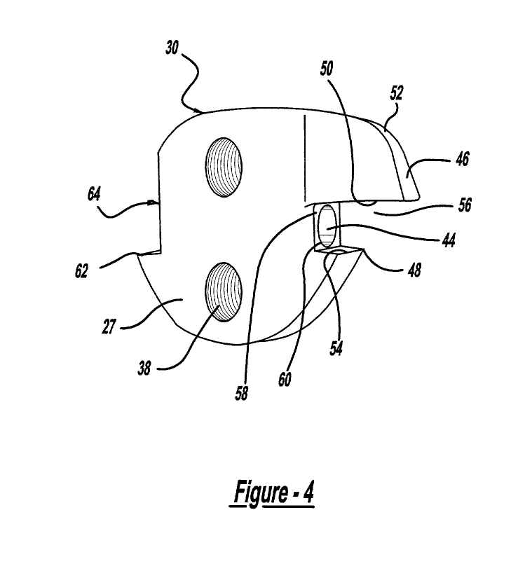

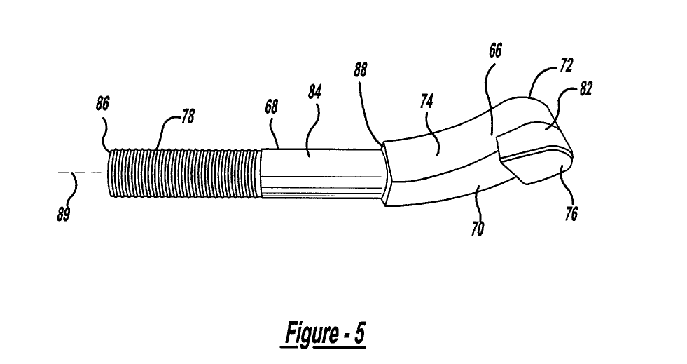

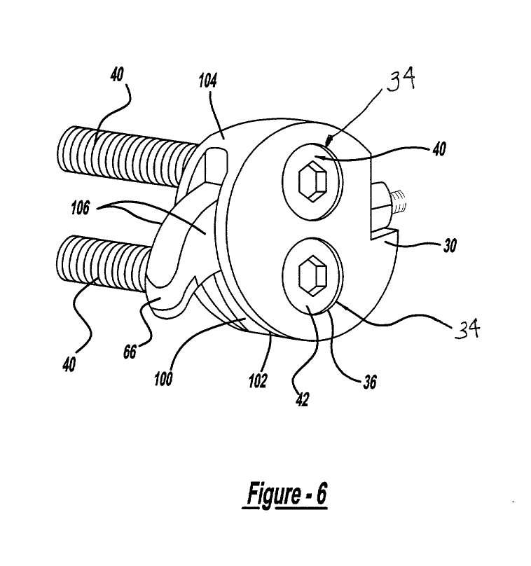

Referring now to FIGS. 2-5, a stump cutting tool 10 according to the present invention is shown in greater detail. The stump cutting tool 10 includes a pocket or tool holder 30 and a cutting tooth 32. As is known in the art, the pocket or tool holder 30 is typically secured to the cutting wheel 16 in pairs wherein one of the pockets 30 includes a throughbore 34 (see FIG. 6) having an adjacent countersunk portion 36 and an opposite pocket having a threaded bore 38. A threaded fastener 40 (see FIG. 6) extends through the throughbore 34 with the head portion 42 thereof disposed within the countersunk portion 36. The threaded fastener 40 extends through an aperture in the cutting wheel 16 and threadably engages the threaded bore 38 on the opposite or complementary pocket 30. Upon tightening the threaded fastener 40, the respective pockets 30 are drawn together and sandwich the cutting wheel 16 therebetween to secure the pockets 30 to the cutting wheel 16. Although only two bolts or threaded fasteners 40 are used in the present embodiment to secure the pockets 30 to the cutting wheel 16, more can also be used. Such a system or method for attaching the pockets 30 to the cutting wheel 16 is well known in the art.

The pocket 30 further includes a bore 44 forming a socket that receives the cutting tooth 32. The bore 44 extends through the pocket 30 from the distal end 48 to the proximal end 62. Although shown herein with a circular cross-section, the bore 44 may have other cross-sectional shapes such as square, hexagonal, star or eccentric provided the cutting tool has a similar cross-sectional shape. A cutting tooth 32 support portion 46 extends outwardly from the distal end 48 of the pocket 30. The support portion 46 includes a support face 50 and a rear surface or edge 52. The support portion 46 tapers inwardly toward the rear surface or edge 52 to reduce the thickness of the support portion 46 and correspondingly reduce the outer surface area that contacts the stump during cutting. Opposite the support face 50 of the support portion 46 is a leading edge support face 54. The leading edge support face 54 cooperates with the support face 50 of the support portion 46 to form a recess 56 in which the cutting tooth 32 is supported. The recess 56 includes a lower or inner surface 58.The bore 44 extends from the lower or inner surface 58 toward the proximal end 62 of the pocket 30. The lower or inner surface 58 of the recess 56 forms a seat 60 adjacent the bore 44 upon which the cutting tool 32 is seated. The seat 60 operates to properly position and locate the cutting tool 32 within the pocket 30. The bottom or proximal end 62 of the pocket 30 includes a notch 64. The notch 64 provides a detent surface that cooperates with a fastener or other retainer, as set forth more fully below, to secure the cutting tooth 32 in the pocket 30.

The cutting tooth 32 includes a head portion 66 and a shank portion 68. The head portion 66 has a parallelepiped shape formed by a front or leading surface 70 and a rear or trailing surface 72 interconnected by opposite side surfaces 74. A notch or recessed portion 82 is located on the front or leading surface 70 of the head portion 66. A cutting tip 76, typically a hardened insert formed of a material such as tungsten carbide, sits in the notch 82 and is secured to the head portion 66 by brazing. It should be understood that any suitable tough material capable of withstanding abrasion and impact can be substituted for the tungsten carbide and affixed by any method used for the given material such as adhesive, solder or welding.

The shank portion 68 is shown in the preferred embodiment with a cylindrically shaped shaft 84. A plurality of threads 78 are formed on the end 86 of the cylindrically shaped shaft 84 opposite the head portion 66. The interface between the head portion 66 and the shank portion 68 defines a shoulder 88 that sits in the recess 56 and engages the seat 60 formed by the lower or inner surface 58 of the pocket 30. The cutting tooth 32 is held in place on the pocket 30 by a nut 80 engaging the threads 78 of the cylindrically shaped shaft 84. It follows that the support face 50 and leading edge support face 54 of the pocket 30 cooperate with the leading surface 70 and trailing surface 72 of the cutting tool 32 to prevent rotation of the cutting tool 32 during the cutting or stump renting operation. In addition, positioning the leading surface 70 and trailing surface 72 of the head portion 66 between the support face 50 and leading edge support face 54 of the pocket 30 provides a means to keep the cutting tool 32 from rotating when tightening or loosening the nut 80. The shoulder 88 also functions as a stop to properly position the cutting tip 76 with respect to the pocket 30. In short, the benefit of the cutting tooth 32 and pocket 30 combination according to the present invention is that the combination is self-gauging. Since the distance between the cutting tip 76 and the shoulder 88 is fixed whenever the cutting tooth 32 is secured within the pocket 30, the cutting tip 76 always extends a fixed distance above the pocket 30.

Although the shank portion 68 is shown herein with a cylindrically shaped shaft 84, the shaft 84 may take or have other cross-sectional shapes. It should be appreciated that the round cross-section of the shaft 84 provides a simple way to manufacture both the cutting tooth 32 and the pocket 30 when compared to various other cross-sections such as hexagonal, square or any other shape or variety. These cross-sectional shapes are, however, suitable alternative designs for the present invention and are therefore encompassed by the present invention. Additionally, the cutting tool 32 is shown held or retained to the pocket 30 with a nut 80 threaded onto the threads 78 of the shaft 84. Other means can also be used to secure the cutting tooth 32 to the pocket 30 including a spring type external or internal lock ring located on the shank portion 68 or bore 44 within the pocket 30 that cooperates with a corresponding groove, a cross pin extending through the pocket 30 and cutting tool 32, and a threaded fastener 40 that is inserted into corresponding internal threads in the shaft member 84.

The support face 50 of the tooth support portion 46 provides added support to the head portion 66 of the cutting tooth 32 during the cutting operation. Further, the support face 50 and leading edge support face 54 cooperate with the head portion 66 of the cutting tooth 32 to prevent rotation of the cutting tooth 32 within the pocket 30 about its longitudinal axis 89 as a result of torosional loads occurring during the cutting operation.

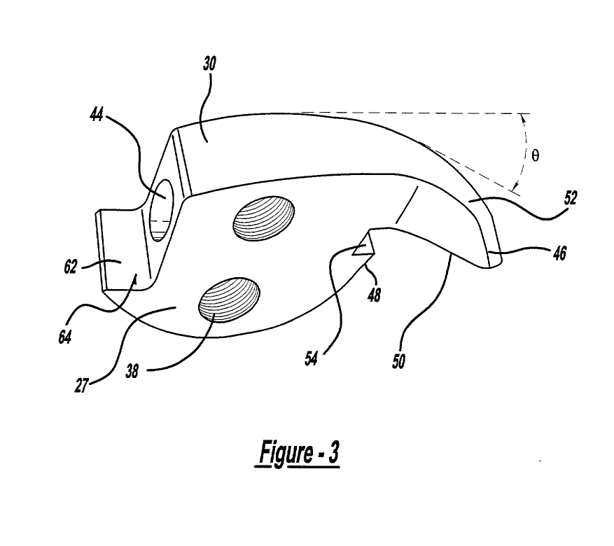

In addition, the pocket 30 and cutting tooth 32 maybe manufactured in both a straight and an angled version (see FIG. 3). Angles 0 from 0 to 45 degrees are typically employed. The width or thickness of the pocket 30 transitions from the body 27 to the tooth support portion 46 wherein the tooth support portion 46 has a width slightly less than the cutter tip 76 width. This transition is employed to achieve maximum bracing while also providing an adequate clearance angle at the cutting tip 76. Typically this is achieved by a taper as set forth above on the tooth support portion 46 of the pocket 30 near the cutting tip 76 or it can be accomplished by an overall reduction of the width of the tooth support portion 46.

The pocket 30 and cutting tooth 32 may be made of any suitable high strength material and by any process that allows manufacture of such material such as forging, cold forming, hot forming, heat treating or casting. Alternate methods of securing or retaining the cutting tool 32 and the pocket 30 include a two-piece, splitbore design as well as a blind-hole bore with the retainer function being served by either a snap ring, set screw or pin. Furthermore, it is possible to omit the bore 44 and use a slot or channel in the pocket 30 to hold the cutting tool 32 without changing the general idea and intended purpose of the present invention which is to capture the cutting tool 32 and hold it in the pocket 30.

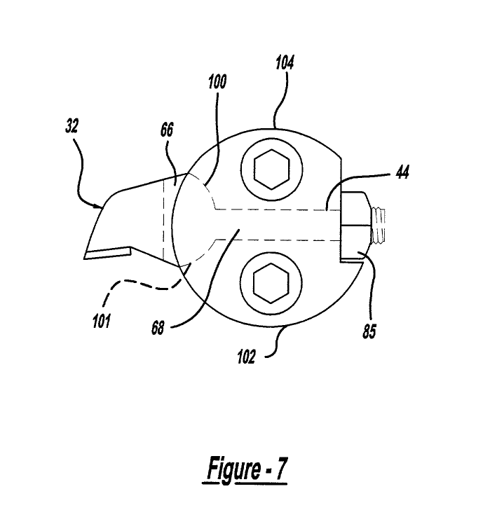

Turning now to FIGS. 6-7, there is shown an alternative embodiment of the present invention. As shown therein, the pocket 30 includes a slot 100 extending from the front edge 102 to the rear edge 104 of the pocket 30. The slot 100 is of a width suitable to trap the respective sides 106 of the head portion 66 of the cutting tooth 32 within the slot 100 to support the head portion 66 and prevent rotation during the cutting operation. It should be understood that the slot 100 need not be flat or perpendicular to the bore 44 extending through the pocket 30. The slot 100 may encompass other geometric shapes that allow for the capture, support and seating of the head portion 66 within the pocket 30. See FIG. 7, showing a cutting tooth 32 having a curvelinear lower surface or shoulder 101. In sum, the slot 100 may take any shape that provides lateral and shear load support of the cutting tooth 32. Again, as with the previous embodiment, the shank portion 68 of the cutting tooth 32 is disposed in the bore 44 and extends through the body of the pocket 30. A retainer, such as a nut 80, is used to secure the cutting tooth 32 to the pocket 30. Once again, the head portion 66 of the cutting tooth 32 is larger than the shank portion 68 and correspondingly provides a stop or detent at the interface of the head portion 66 and shank portion 68. It is also within the present invention to use a cutting tooth 32 having a smaller head portion 66 that uses other means such as a pin extending into the shank portion 66 or a protrusion formed as part of the shank portion 66 as a stop or detent to properly position the cutting tooth 32.

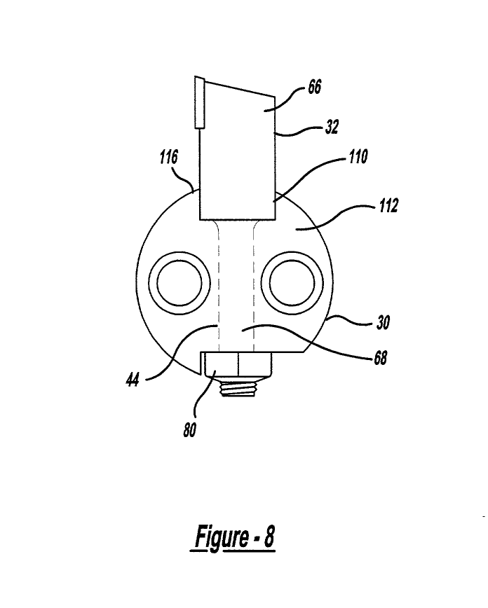

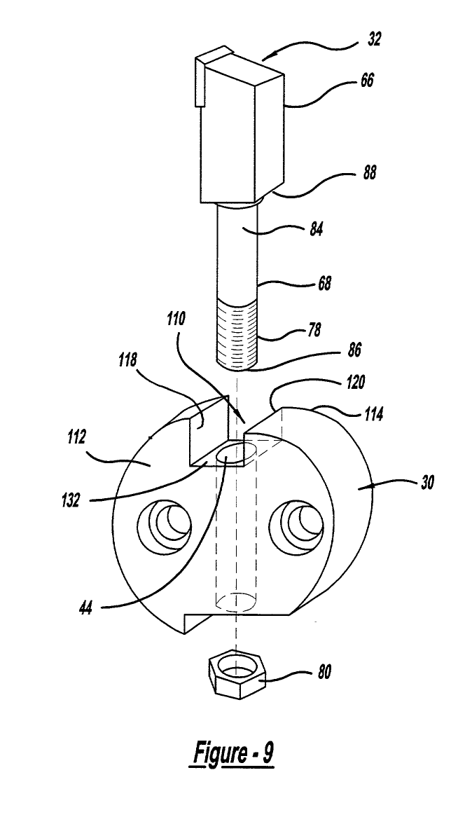

FIGS. 8-9 show an additional embodiment of the present invention. Once again, the invention in its base form includes a cutting tooth 32 extending through a bore 44 on a pocket or tool holder 30 wherein the shank portion 68 of the cutting tooth 32 is disposed within the bore 44 and a fastener or nut 80 connects to the shank portion 68 to retain the cutting tooth 32 on the pocket 30. A notch 110 is cut in the upper surface 116 of the circular shaped pocket 30. The notch 110 extends from the outer side surface 112 of the pocket 30 to the inner side surface or mounting face 114 of the pocket 30. The notch 110 forms front 118 and rear 120 support surfaces that engage the head portion 66 of the cutting tooth 32 to provide lateral and shear load support of the cutting tooth 32. As with the previous embodiments, the interface between the shank portion 68 and head portion 66 of the cutting tooth 32 forms the shoulder 88 or stop that engages the lower surface 122 of the notch 110. Again, the shank portion 68 of the cutting tooth 32 includes an elongated, cylindrically shaped shaft 84 having a plurality of threads 78 on one end 86. The shaft 84 passes through the bore 44 and a nut 80 engages the threads 78 to secure the cutting tooth 32 on the pocket 30.

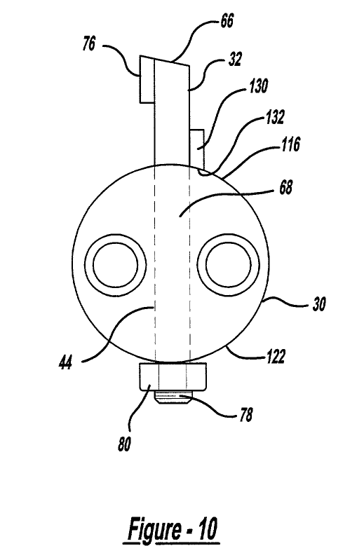

FIG. 10 illustrates a further alternative embodiment of the present invention. As shown therein, the tool holder or pocket 30 has a generally circular shape having a bore 44 extending generally in a direction from the upper surface 116 to the lower surface 128 thereof. The bore 44 has a square cross-section. A cutting tooth 32 having a shank portion 68 with a square cross-section complementary to the cross-section of the bore 44 fits in the 44 bore. It should be understood that it is the complementary cross-sectional shape of the bore 44 and shank portion 68 that prevent rotation of the cutting tooth 32 within the pocket 30. A stop 130 is mounted to the shank portion 68. The stop 130 is attached to the shank portion 68 by brazing, welding or an industrial adhesive. The stop 130 may also be formed as part of the shank portion 68. The stop 130 sits on the upper surface 116 of the pocket 30 to positively locate the cutting tip 76. As with the previous embodiments, a nut 80 engages threads 78 on the shank portion 68 of the cutting tooth 32 to secure the cutting tooth 32 to the pocket 30. Such a device is simplistic in nature. The cutting tool 32 is a square piece of bar stock. A cutting tip 76 is affixed to one end thereof. The opposite end thereof maybe threaded or have a slot for a retaining clip. The stop 130 is attached to the shank portion 68 and may have a curved or arcuate surface 132 that engages the upper surface 116 of the circular shaped pocket 30. As with the previous embodiments, the upper and lower surfaces 116,122 maybe milled to form a flat surface.

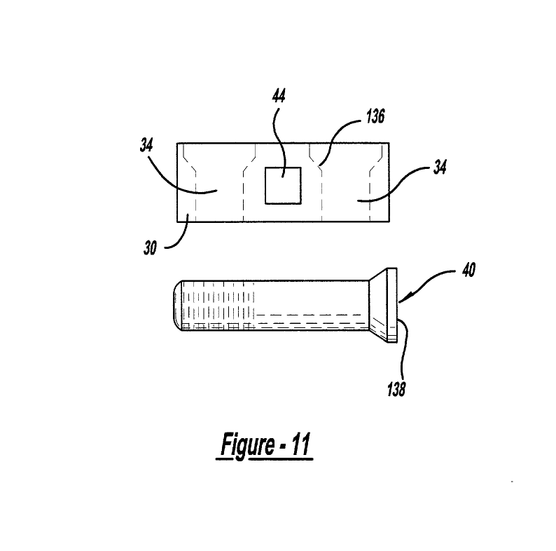

Referring to FIG. 11, as the threaded fastener 40 spacing for connecting a pocket 30 to a cutting wheel 16 is standard in the industry, in some instances, a standard socket head screw or threaded fastener used to secure the pocket 30 to the cutting wheel 16 may not be suitable. Accordingly, the invention also includes the use of flat head screws 138 and a shallow countersunk portion 136 to provide additional area for the bore 44.

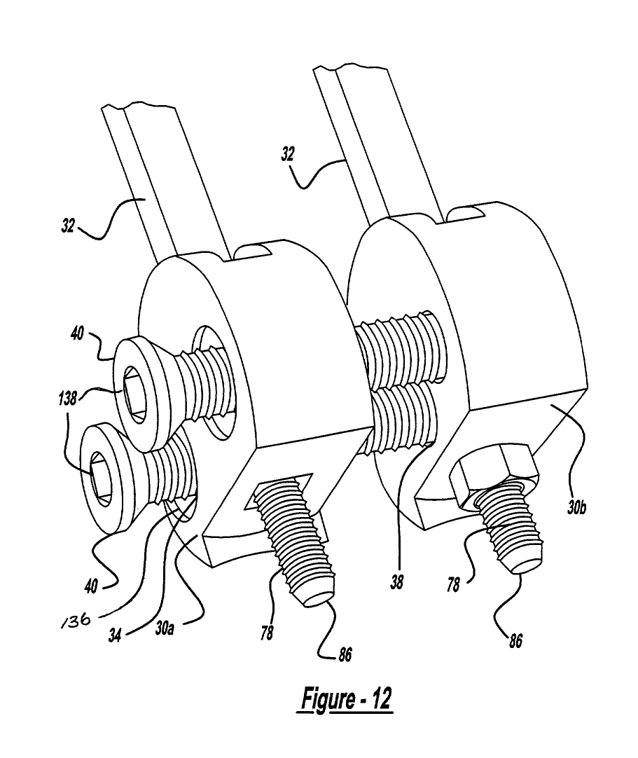

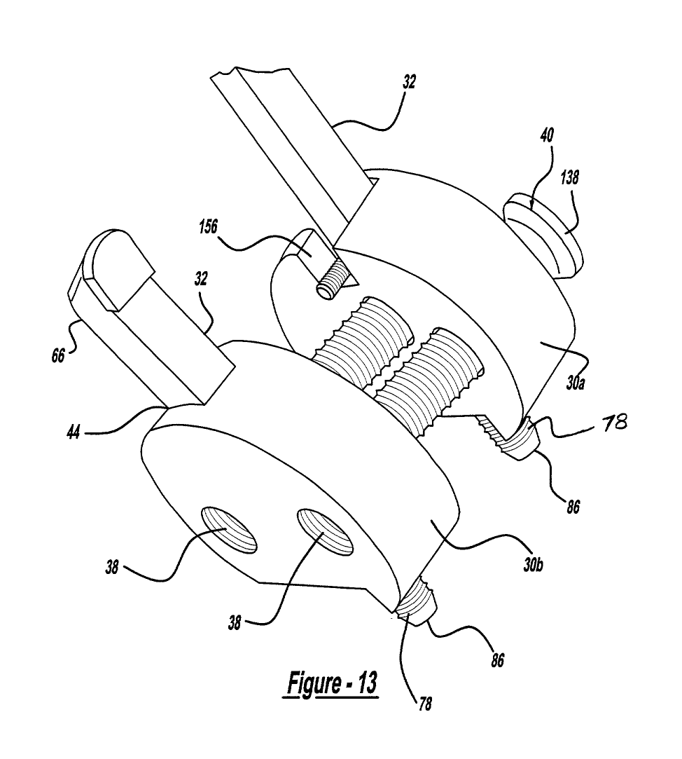

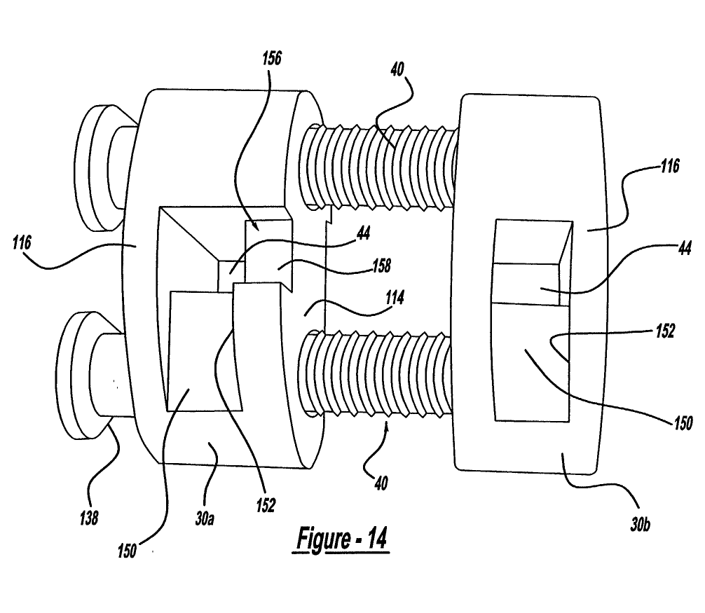

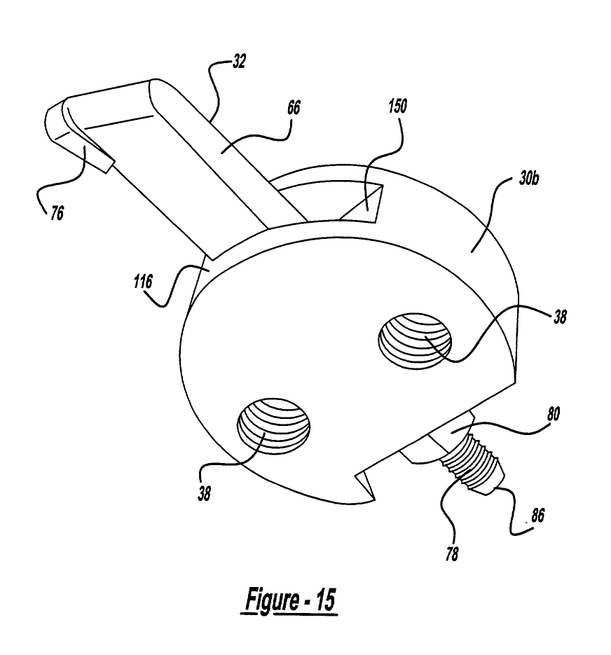

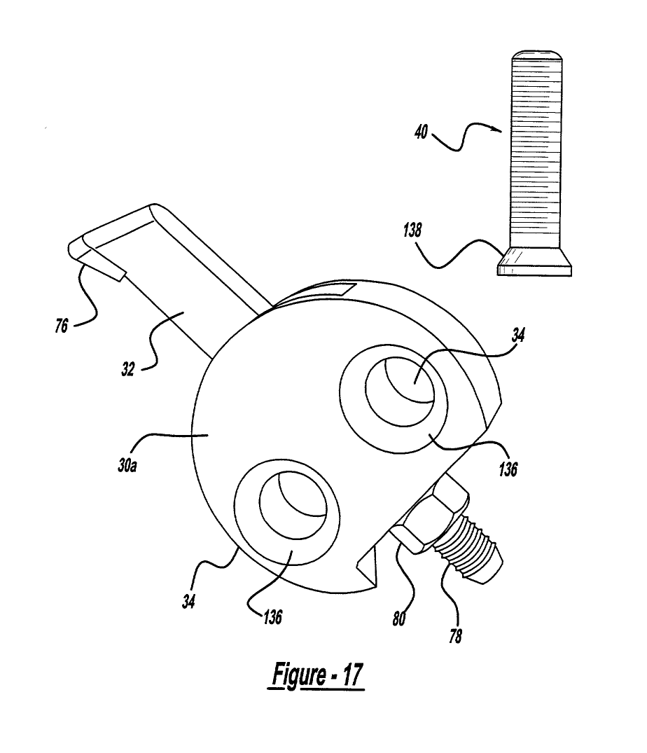

FIGS. 12-21 disclose a further embodiment of a stump cutting tool assembly 10 according to the present invention. As shown in FIG. 12, the cutting tool according to the present invention includes first and second pockets 30a, 30b. Each of the pockets 30a, 30b having a cutting tooth 32 secured therein. Each of the pockets 30a, 30b are identical except, as set forth previously, a plurality of threaded fasteners 40 extend through a throughbore 34 in the first pocket 30a and are threadably received in the threaded bore 38 in the second pocket 30b. For the purposes of illustration only, the pocket 30a differs from the pocket 30b only to disclose an additional embodiment having a notch 156 for a purpose that is explained below. Again, the threaded fastener 40 is a flat head screw 138 that is seated in a shallow countersunk portion 136 of the first pocket 30a. As shown in FIG. 14, the bore 44 in which the cutting tooth 32 is positioned has a square cross-section and receives a square cross-section shank portion 68 of the cutting tooth 32. Use of the square bore 44 enables the cutting tooth 32 to be made of square bar stock having threads 78 formed on the end 86 opposite the head portion 66 of the cutting tooth 32. Accordingly, the complementary square cross-sections prevent rotation of the cutting tooth 32.

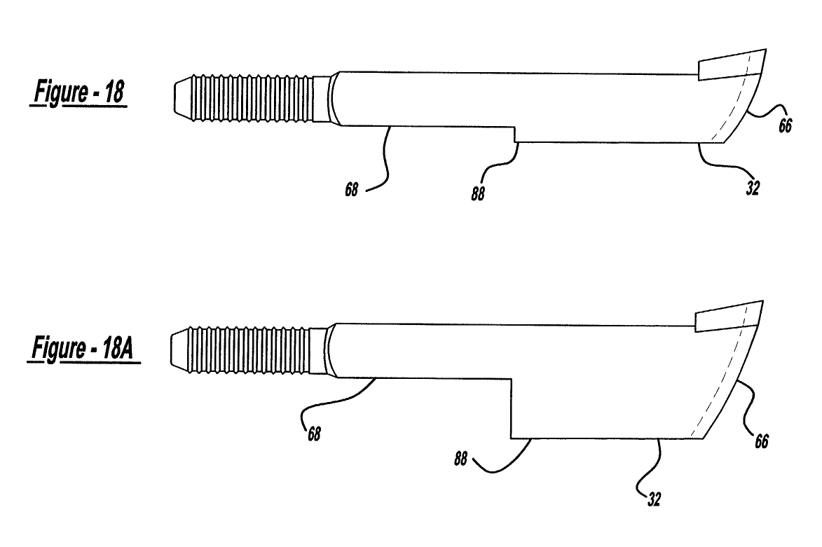

As shown in FIGS. 18 and 18a, the cutting tooth 32 may include an enlarged head portion 66, i.e. larger than the shank portion 68. The enlarged head portion 66 forms a shoulder 88 that rests on the seat 150 formed by a groove 152 milled into the upper surface 116 of the pocket 30. Accordingly, the size of the shoulder 88 is variable depending upon the amount of support needed for the cutting tooth 32 during the cutting operation.

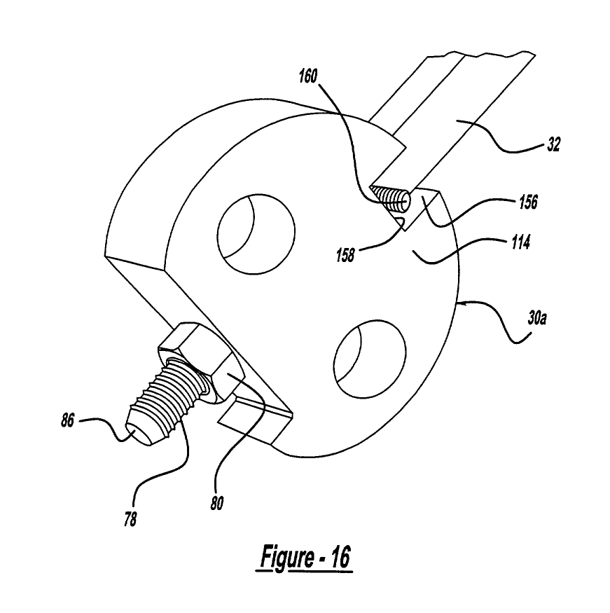

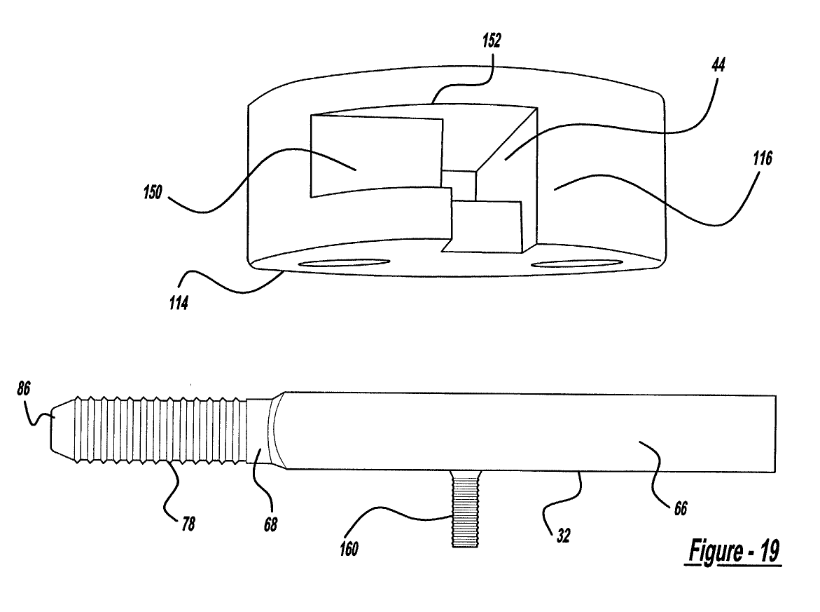

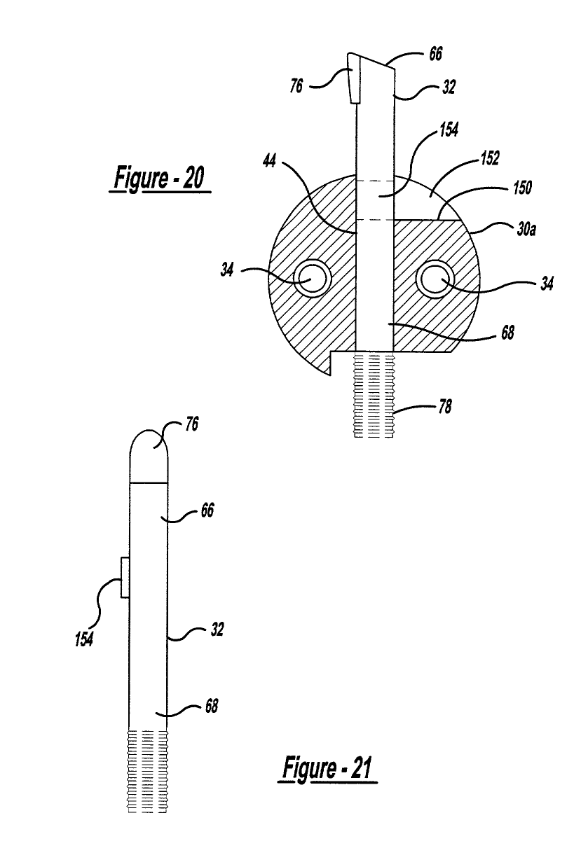

In some instances, it is desirous to have the cutting tooth 32 bend or deflect when the cutting tooth 32 strikes a hard object such as a rock, to reduce the stress on the stump cutting apparatus 12 and prevent damage to the stump cutting apparatus 12. In such instances, the cutting tooth 32 (see FIGS. 16, 19-21) includes a stop 154 attached thereto. The stop 154 is disposed within a slot or notch 156 located on the interior or mounting face 114 of the pocket 30. The stop 154 rests on a lower or seat surface 158 formed by the notch 156. Accordingly, the cutting tooth 32 and corresponding cutting tip 76 is properly positioned within the pocket 30. Placing the notch 156 on the inner side or mounting face 114 protects the stop 154 and reduces the possibility of abrasion thereof during the cutting operation. The stop is shown in FIGS. 16 and 19 as a screw 160, as shown in FIGS. 20-21, the stop 154 may be formed from a small piece of bar stock that is welded to the side of the cutting tooth 32. Finally, similar to the embodiment shown in FIG. 10, the stop 154 can also face rearward and engage the seat 150.

In addition, the bore 44 in the disclosed embodiments can be a blind bore. Thus, the cutting tooth 32 will not extend all the way through the pocket 30 to the lower surface thereof. In such a case, a pin or snap ring maybe used to secure the tooth 32 in the pocket 30. Also, a screw may extend inwardly from inside surface of the pocket 30 and engage the cutting tooth 32.

The invention has been described in an illustrative manner. It is to be understood that the terminology which has been used is intended to be in the nature of words of description rather than of limitation.

Many modifications and variations of the invention are possible in light of the above teachings. Therefore, within the scope of the appended claims, the invention may be practiced other than as specifically described.

I claim

1. A stump cutting tool for use with a stump cutting apparatus comprising:
a pocket removeably secured to the stump cutting apparatus, said pocket having a bore extending very and from a distal end of said pocket to a proximal end of said pocket; and
a cutting tool disposed and retained within said bore, said cutting tooth having a cutting tip attached thereto.
